(19) United States
(12) Patent Application Publication
(10) Pub. No.: US 2021/0192657 A1
(43) Pub. Date: Jun. 24, 2021

(54) INFORMATION PROVIDING APPARATUS, TERMINAL, IDENTITY VERIFICATION SYSTEM, INFORMATION PROVIDING METHOD, AND STORAGE MEDIUM

(71) Applicant: NEC Corporation, Tokyo (JP)

(72) Inventors: Katsuya NAKASHIMA, Tokyo (JP); Akihiro IWANAMI, Tokyo (JP); Koui NORIMATSU, Tokyo (JP); Yusuke ASHIDA, Tokyo (JP)

(73) Assignee: NEC Corporation, Tokyo (JP)

(21) Appl. No.: 17/057,324

(22) PCT Filed: May 20, 2019
(86) PCT No.: PCT/JP2019/019948

§ 371 Date: Nov. 20, 2020

(30) Foreign Application Priority Data
May 22, 2018 (JP) 2018-097942

(51) Int. Cl. G06Q 50/26; G06F 21/30

(52) U.S. Cl. CPC G06Q 50/265; G06F 21/30

(57) ABSTRACT

Provided are an information providing apparatus, a terminal, an identity verification system, an information providing method, and a storage medium that can perform identity verification with high usability without requiring a passenger to possess or carry a certificate or a substitute thereof. The information providing apparatus includes: a management unit that creates identity verification information on a passenger based on passage history information including biometric information on the passenger; and a transmission unit that, in response to receiving biometric information on a target person and a request for the identity verification information, transmits the identity verification information including the biometric information that matches the biometric information on the target person.

### TECHNICAL FIELD

The present invention relates to an information providing apparatus, a terminal, an identity verification system, an information providing method, and a storage medium.

### BACKGROUND ART

Patent Literature 1 discloses a passport information system that causes a mobile information terminal possessed by a user to store passport information and uses the mobile information terminal as a passport.

### CITATION LIST

### Patent Literature

PTL 1: Japanese Patent Application Laid-open No. 2017-182388

### SUMMARY OF INVENTION

### Technical Problem

In the passport information system disclosed in Patent Literature 1, a person asked to present a passport or the like is able to use a mobile information terminal instead of presenting a passport. In such a passport information system, however, since it is necessary to possess a mobile information terminal instead of a passport, it is not possible to perform identity verification when the person does not possess the mobile information terminal instead of a passport.

In view of the problem described above, the present invention intends to provide an information providing apparatus, a terminal, an identity verification system, an information providing method, and a storage medium that can perform identity verification with high usability without requiring a passenger to possess or carry a certificate or a substitute thereof.

### Solution to Problem

According to one example aspect of the present invention, provided is an information providing apparatus including: a management unit that creates identity verification information on a passenger based on passage history information including biometric information on the passenger; and a transmission unit that, in response to receiving biometric information on a target person and a request for the identity verification information, transmits the identity verification information including the biometric information that matches the biometric information on the target person.

According to another example aspect of the present invention, provided is a terminal configured to communicate with an information providing apparatus, the information providing apparatus includes a management unit that creates identity verification information on a passenger based on passage history information including biometric information on the passenger and a transmission unit that, in response to receiving biometric information on a target person and a request for the identity verification information, transmits the identity verification information including the biometric information that matches the biometric information on the target person, and the terminal includes: a transmission unit that transmits the biometric information on the target person and the request for the identity verification information to the information providing apparatus; and a receiving unit that receives a response to the request from the information providing apparatus.

According to yet another example aspect of the present invention, provided is an identity verification system including: an information providing apparatus; and a terminal configured to communicate with the information providing apparatus, the information providing apparatus includes a management unit that creates identity verification information on a passenger based on passage history information including biometric information on the passenger and a transmission unit that, in response to receiving biometric information on a target person and a request for the identity verification information, transmits the identity verification information including the biometric information that matches the biometric information on the target person, and the terminal includes a transmission unit that transmits the biometric information on the target person and the request for the identity verification information to the information providing apparatus, and a receiving unit that receives a response to the request from the information providing apparatus.

According to yet another example aspect of the present invention, provided is an information providing method including: creating identity verification information on a passenger based on passage history information including biometric information on the passenger; and in response to receiving biometric information on a target person and a request for the identity verification information, transmitting the identity verification information including the biometric information that matches the biometric information on the target person.

According to yet another example aspect of the present invention, provided is a storage medium storing a program that causes a computer to perform: creating identity verification information on a passenger based on passage history information including biometric information on the passenger; and in response to receiving biometric information on a target person and a request for the identity verification information, transmitting the identity verification information including the biometric information that matches the biometric information on the target person.

### Advantageous Effects of Invention

According to the present invention, a passenger is not required to hold or carry a certificate or a substitute thereof, and identity verification can be performed with high usability.

### BRIEF DESCRIPTION OF DRAWINGS

FIG. 1 is a schematic diagram illustrating a general configuration of an identity verification system according to a first example embodiment of the present invention.

FIG. 2 is a block diagram illustrating an example of a hardware configuration of a management server, an information server, an identity verification server, and a facility terminal in the identity verification system according to the first example embodiment of the present invention.

FIG. 3 is a block diagram illustrating an example of a hardware configuration of a mobile terminal in the identity verification system according to the first example embodiment of the present invention.

FIG. 4 is a sequence diagram illustrating the operation of the information server, the management server, the identity verification server, the facility terminal, and the mobile terminal in the identity verification system according to the first example embodiment of the present invention.

FIG. 5 is a schematic diagram illustrating an example of a passenger information database of the information server according to the first example embodiment of the present invention.

FIG. 6 is a schematic diagram illustrating an example of a passage history information database of the management server according to the first example embodiment of the present invention.

FIG. 7 is a schematic diagram illustrating an example of a temporary information database of the management server according to the first example embodiment of the present invention.

FIG. 8 is a schematic diagram illustrating an example of an identity verification information database of the identity verification server according to the first example embodiment of the present invention.

FIG. 9 is a sequence diagram illustrating the operation of an information server, a management server, an identity verification server, and a mobile terminal in an identity verification system according to a second example embodiment of the present invention.

FIG. 10 is a block diagram illustrating a configuration of an identity verification system according to another example embodiment of the present invention.

### DESCRIPTION OF EMBODIMENTS

### First Example Embodiment

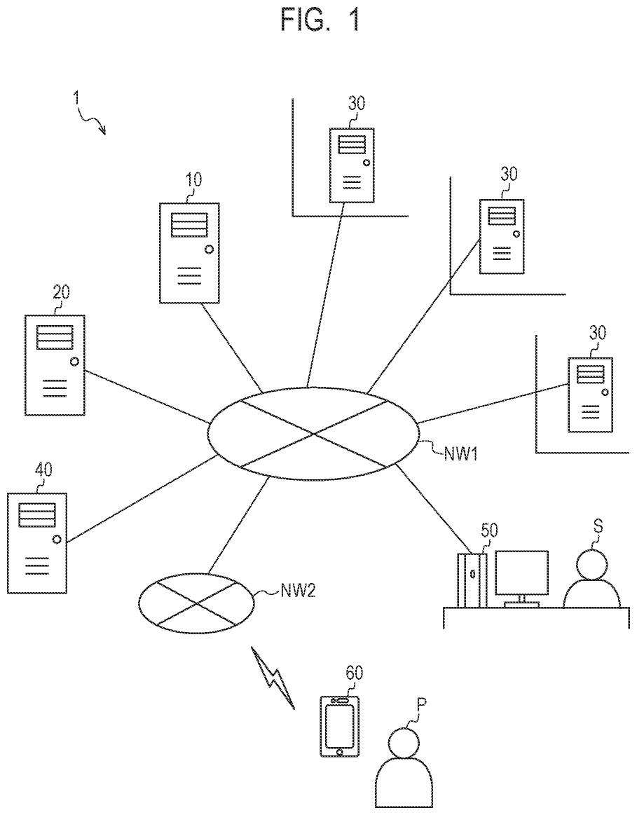

An information providing apparatus, a terminal, an identity verification system, and an information providing method according to a first example embodiment of the present invention will be described with reference to FIG. 1 to FIG. 8.

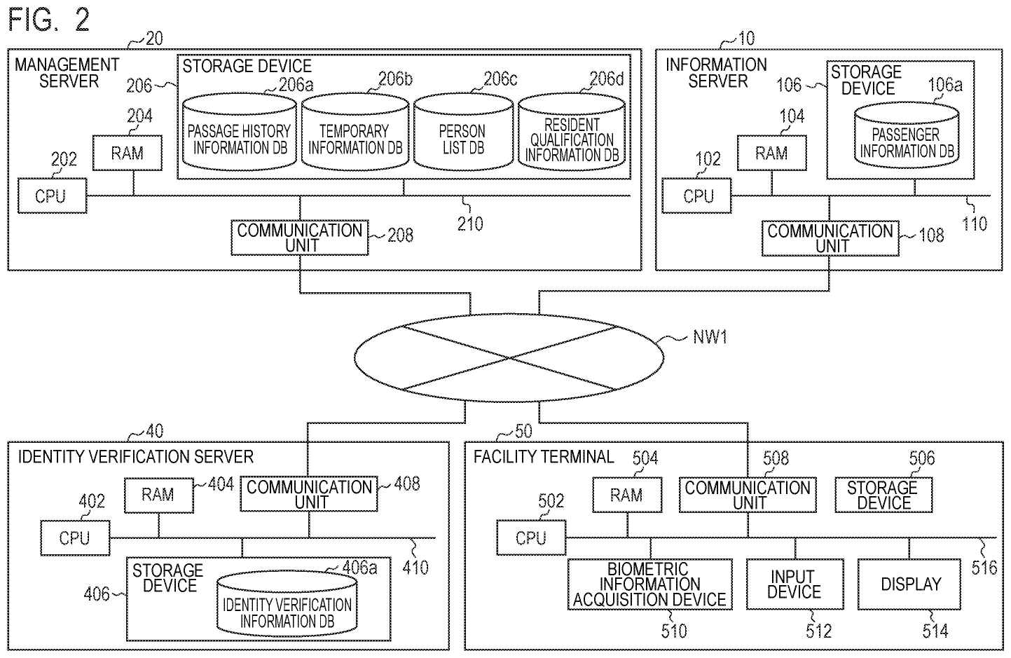

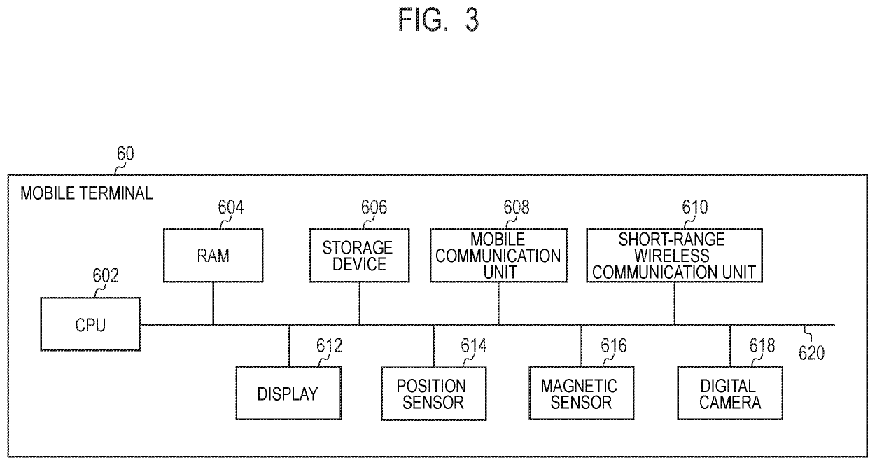

First, a configuration of the identity verification system according to the present example embodiment will be described with reference to FIG. 1 to FIG. 3. FIG. 1 is a schematic diagram illustrating a general configuration of the identity verification system according to the present example embodiment. FIG. 2 is a block diagram illustrating an example of a hardware configuration of a management server, an information server, an identity verification server, and a facility terminal in the identity verification system according to the present example embodiment. FIG. 3 is a block diagram illustrating an example of a hardware configuration of a mobile terminal in the identity verification system according to the present example embodiment.

As illustrated in FIG. 1, an identity verification system 1 according to the present example embodiment includes an information server 10, a management server 20, company servers 30, an identity verification server 40, a facility terminal 50, and a mobile terminal 60. For example, for a foreigner passenger P who enters and stays in the country in which the identity verification system 1 is operated, the identity verification system 1 according to the present example embodiment performs identity verification in a facility such as an accommodation facility, a shop, a commercial facility, a public facility, or the like used by the passenger P during the stay. In the following, a country in which the identity verification system 1 is operated will be simply referred to as “the country of interest” where appropriate. Note that the identity verification system 1 may perform identity verification for the foreigner passenger P in any facilities in the country of interest. Further, a foreigner is a person who does not have the nationality of the country of interest.

The information server 10 is installed in a facility of an institute or a company that manages and operates the information processing system used for procedure related to arrival and departure of an airplane or the like in the country of interest, for example. The management server 20 is installed in a facility of an administration office that manages departure from and entry to the country of interest, for example. The identity verification server 40 is installed in a facility of an institute or a company that manages and operates the identity verification system 1, for example. The facility terminal 50 is a terminal installed in a facility that performs identity verification when used for the passenger P during a stay in the country of interest. The mobile terminal 60 is a terminal possessed or carried and used by the passenger P.

Each company server 30 is a server managed and operated by an airline company that operates an airplane used by the passenger P who makes a passage to the country of interest from a foreign country. Note that the company server 30 may be a server managed and operated by a company that operates passenger transport business to operate a transportation system such as a ship other than airplanes used by the passenger P who makes a passage to the country of interest from a foreign country.

The information server 10, the management server 20, the company servers 30, the identity verification server 40, and the facility terminal 50 are connected to a network NW1. The network NW1 is formed of a Wide Area Network (WAN), a Local Area Network (LAN), or the like. A mobile communication network NW2 is connected to the network NW1. The mobile terminal 60 can be connected to the network NW1 via the mobile communication network NW2.

The information server 10 and the management server 20 can communicate with each other via the network NW1. The information server 10 and the company server 30 can communicate with each other via the network NW1. The management server 20 and the identity verification server 40 can communicate with each other via the network NW1. The identity verification server 40 and the facility terminal 50 can communicate with each other via the network NW1. The identity verification server 40 and the mobile terminal 60 can communicate with each other via the network NW1 and the mobile communication network NW2.

The information server 10 functions as an information management apparatus that manages passenger information, which is information related to the passenger P who makes a passage to the country of interest from a foreign country. The company server 30 transmits and reports the passenger information on the passenger P heading toward the country of interest using an airplane of the airline company to the information server 10 via the network NW1. For example, the company server 30 transmits and reports passenger information to the information server 10 in advance by a predetermined period before departure of an airplane used by the passenger P or at a predetermined point of time before the departure. Further, for example, the company server 30 can transmits passenger information to the information server 10 between the time when passage information is finalized after the passenger P makes check-in and the time when entry inspection in the country of interest for entry is performed, more specifically, between check-in and takeoff of an airplane. Further, for example, the company server 30 may transmit passenger information to the information server 10 between the time when the passenger P makes check-in and the time when the airplane arrives or the passenger comes to the entry inspection site. The information server 10 registers passenger information transmitted from the company server 30 of each airline company in a passenger information database (DB) 106a and manages the passenger information as described later.

The information server 10 has a central processing unit (CPU) 102, a random access memory (RAM) 104, a storage device 106, and a communication unit 108, as illustrated in FIG. 2. The CPU 102, the RAM 104, the storage device 106, and the communication unit 108 are connected to a bus line 110.

The CPU 102 functions as a control unit that operates by executing a program stored in the storage device 106 and controls the operation of the overall information server 10. Further, the CPU 102 executes an application program stored in the storage device 106 and performs various processes as the information management apparatus. The RAM 104 provides a memory area required for the operation of the CPU 102.

More specifically, the CPU 102 functions as a management unit and stores, in the storage device 106, and manages passenger information reported in advance from the company servers 30 of respective airline companies that operate international flights to the country of interest. The CPU 102 registers passenger information in the passenger information DB 106a stored in the storage device 106 and manages the passenger information. In a foreign country, passengers depart toward the country of interest for various purposes such as tourism, business, return to the country, temporary return, or the like. Such passenger information on various passengers P is acquired at reservation of an airplane, a boarding procedure, or the like in airline companies of respective countries. The company server 30 transmits and reports the acquired passenger information to the information server 10 via the network NW1 in advance as described above. The CPU 102 aggregates and registers passenger information, which is reported in advance from the company servers 30 of airline companies of respective countries, in the passenger information DB 106a of the storage device 206.

Further, the CPU 102 functions as a providing unit and transmits and provides passenger information to the management server 20 via the network NW1. The CPU 102 regularly or irregularly provides passenger information to the management server 20 in advance before entry of the passenger P to the country of interest.

The storage device 106 is formed of a storage medium such as a nonvolatile memory, a hard disk drive, or the like and functions as a storage unit. The storage device 106 stores a program executed by the CPU 102, data referenced by the CPU 102 when executing the program, or the like.

Further, the storage device 106 stores the passenger information DB 106a. The passenger information described above is registered in the passenger information DB 106a.

The passenger information registered in the passenger information DB 106a is information related to the passenger P heading toward the country of interest. For example, the passenger information includes passport information, itinerary information, or the like on the passenger P. The passport information includes a passport number, a passport issuance country, identity information, or the like of a passport issued for the passenger P. The identity information includes the name, the nationality, the date of birth, the sexuality, or the like of the passenger P. The itinerary information includes a departure place, an arrival place, an airline company to use, a flight number, a departure date and time, an arrival data and time, or the like of the passenger P. An airline company, a flight number, a departure date and time, and an arrival data and time form flight information. The departure date and time may instead be a departure date not including time. The arrival date and time may instead be an arrival date not including time. The departure place and the arrival place may mean an airport of departure and an airport of destination, respectively. The passenger information and the passport information and the itinerary information included in the passenger information are associated with each other.

The communication unit 108 is connected to the network NW1 and transmits and receives data via the network NW1. The communication unit 108 performs communication between the management server 20, the company servers 30, or the like under the control of the CPU 102.

The information server 10 is configured in such a way.

The management server 20 functions as a management apparatus that stores and manages various information required for immigration inspection operation of the country of interest. As illustrated in FIG. 2, the management server 20 has a CPU 202, a RAM 204, a storage device 206, and a communication unit 208. The CPU 202, the RAM 204, the storage device 206, and the communication unit 208 are connected to a bus line 210.

The CPU 202 functions as a control unit that operates by executing a program stored in the storage device 206 and controls the operation of the overall management server 20. Further, the CPU 202 executes an application program stored in the storage device 206 and performs various processes as the management apparatus. The RAM 204 provides a memory area required for the operation of the CPU 202.

More specifically, the CPU 202 functions as a management unit and records and manages passage history information regarding immigration of the passenger P in the country of interest in the storage device 206. The CPU 202 registers passage history information in the passage history information DB 206a stored in the storage device 206 and manages the passage history information. In the country of interest, foreigners enter the country from various foreign countries for various purposes such as tourism, business, or the like, and the foreigners who have entered the country then depart from the country. Further, in the country of interest, citizens of the country and foreign residents depart from the country for various purposes such as tourism, business, temporary homecoming, or the like, and the citizens of the country and the foreign residents who have departed from the country then enter the country. Such various passage history information on the passenger P is acquired by the face-to-face inspection booth in the entry inspection site, an automated gate, or the like and transmitted to the management server 20, for example. The CPU 202 stores and manages the transmitted passage history information in the storage device 206.

Further, the CPU 202 functions as a passenger information acquisition unit and acquires passenger information provided from the information server 10 via the network NW1.

Further, the CPU 202 functions as a management unit and creates a temporary information DB 206b from the passage history information DB 206a based on passenger information provided and acquired from the information server 10. The CPU 202 refines passage history information in the passage history information DB 206a based on passenger information. Accordingly, compared to the passage history information in the passage history information DB 206a, the CPU 202 creates the temporary information DB 206b in which the refined and reduced number of pieces of passage history information are registered. Details of creation of the temporary information DB 206b will be described later. The CPU 202 stores the created temporary information DB 206b in the storage device 206.

Further, the CPU 202 functions as a management unit and stores and manages, in the storage device 206, a person list including a watch list and a trusted list. The CPU 202 registers and manages a person list in a person list DB 206c stored in the storage device 206. The watch list is a list that registers person information including biometric information on a person under surveillance who requires special attention in immigration inspection or who is to be rejected before immigration. The trusted list is a list that registers person information including biometric information on a person who is to be permitted for entry to the country. A person list is used for matching at an automated gate or matching at the inspection booth, for example. Note that the person list is not necessarily required to include both the watch list and the trusted list but may include either one of the watch list and the trusted list.

The storage device 206 is formed of a storage medium such as a nonvolatile memory, a hard disk drive, or the like and functions as a storage unit. The storage device 206 stores a program executed by the CPU 202, data referenced by the CPU 202 when executing the program, or the like.

Further, the storage device 206 stores a passage history information DB 206a, a temporary information DB 206b, and a person list DB 206c. Furthermore, the storage device 206 stores a resident qualification information DB 206d. The passage history information described above is registered in the passage history information DB 206a. The refined passage history information described above is registered in the temporary information DB 206b. The person list described above is registered in the person list DB 206c. The resident qualification information on the passenger P is registered in the resident qualification information DB 206d.

The passage history information registered in the passage history information DB 206a is information regarding the passenger P having a passage history of entry to the country of interest. For example, the passage history information is registered when the passenger P enters the country of interest and when the passenger P departs from the country of interest. For example, the passage history information includes passport information, biometric information, history information, and the like on the passenger P having a passage history to the country of interest. The passport information includes a passport number, a passport issuance country, identity information, or the like of a passport issued for the passenger P. The identity information includes the name, the nationality, the date of birth, the sexuality, or the like of the passenger P. The biometric information is a fingerprint image, a face image, an iris image, a finger vein image, a palm-print image, a palm vein image, or the like of the passenger P. One or multiple pieces of biometric information may be used. Further, the biometric information may be acquired from integrated circuit (IC) passport in which biometric information on the passenger P is stored or may be acquired directly from the passenger P in inspection. The history information includes an entry country, a date of entry, a departure country, a date of departure, a flight number, or the like on the passenger P. The entry country and the departure country may mean an airport for entry to the country and an airport for departure from the country, respectively. The passage history information and the passport information, biometric information, and history information included in the passage history information are associated with each other.

The passage history information registered in the temporary information DB 206b is passage history information associated with personal identification information of the passenger P included in passenger information which satisfies a particular condition in the passenger information DB 106a out of passage history information registered in the passage history information DB 206a. That is, the passage history information registered in the temporary information DB 206b is passage history information corresponding to passenger information which satisfies the particular condition in the passenger information DB 106a out of passage history information registered in the passage history information DB 206a. The particular condition may be, for example, a condition that the departure date and time or the departure date of the passenger information is included in a predetermined period, a condition that the arrival date and time or the arrival date of the passenger information is included in a predetermined period, the departure place of the passenger information is a particular place of destination, that is, a particular airport or a group of particular airports, or the like as described later. Further, the personal identification information on the passenger P is not particularly limited and is a passport number, for example. Further, the personal identification information may be, for example, a combination of two or more pieces of identity information such as a name, a nationality, a date of birth, or the like. The passage history information registered in the temporary information DB 206b is matching-use passage history information used for matching of identity verification in entry inspection at an inspection booth or an automated gate.

The person list registered in the person list DB 206c includes a watch list and a trusted list. In the watch list, biometric information, text information, or the like is registered as person information on a person under surveillance who requires special attention in immigration inspection or who is to be rejected before immigration. Further, in the trusted list, biometric information, text information, or the like is registered as person information on a person who is to be permitted for entry to the country. The biometric information included in each person information of the watch list and the trusted list may be, for example, a fingerprint image, a face image, an iris image, a finger vein image, a palm-print image, a palm vein image, or the like of the person of interest.

Resident qualification information registered in the resident qualification information DB 206d is information related to resident qualification of the passenger P who stays in the country of interest. The resident qualification information includes passport information on the passenger P, a specific type of the resident qualification of the passenger P, a period of stay, or the like. For example, resident qualification information is acquired in entry inspection of the passenger P at an airport and registered in the resident qualification information DB 206d. The resident qualification period may differ in accordance with the municipal law of the country of interest, resident qualification, or the like and may be, for example, 90 days when the resident qualification is for a short stay, 4 years when the resident qualification is for studying abroad, 1 year when the resident qualification is for training, or the like.

The communication unit 208 is connected to the network NW1 and transmits and receives data via the network NW1. The communication unit 208 communicates with the information server 10, the identity verification server 40, or the like under the control of the CPU 202.

The management server 20 is configured in such a way.

The identity verification server 40 functions as an information providing apparatus that provides identity verification information to the facility terminal 50 of a facility to perform identity verification via the network NW1. As illustrated in FIG. 2, the identity verification server 40 includes a CPU 402, a RAM 404, a storage device 406, and a communication unit 408. The CPU 402, the RAM 404, the storage device 406, and the communication unit 408 are connected to a bus line 410.

The CPU 402 functions as a control unit that operates by executing a program stored in the storage device 406 and controls the operation of the overall identity verification server 40. Further, the CPU 402 executes an application program stored in the storage device 406 and performs various processes as the information providing apparatus. The RAM 404 provides a memory area required for the operation of the CPU 402.

Further, the CPU 402 functions as a management unit and creates an identity verification information DB 406a from the temporary information DB 206b of the management server 20. The CPU 402 extracts, from the temporary information DB 206b, passage history information associated with personal identification information on the passenger P who has permitted a use of the passage history information intended for identity verification. Furthermore, the CPU 402 creates identity verification information on the passenger P from the extracted passage history information.

The CPU 402 creates identity verification information from passage history information on various temporary information DB 206b created in accordance with various particular conditions and accumulates the identity verification information. The created identity verification information will be identity verification information related to the passenger P who stays the country of interest after entry inspection. The CPU 402 registers the accumulated identity verification information in a database and thereby creates the identity verification information DB 406a in which identity verification information on the passenger P who has permitted a use of the passage history information intended for identity verification is registered. Note that the CPU 402 can also create identity verification information without requiring permission of a use of passage history information intended for identity verification. The identity verification information in the identity verification information DB 406a is identity verification information related to the passenger P who has entered the country of interest after entry inspection and is staying in the country of interest, which is the passenger P whose period of stay has not yet expired or who has not yet departed from the country. Details of creation of the identity verification information DB 406a will be described later. The CPU 402 stores the created identity verification information DB 406a in the storage device 406.

In such a way, the CPU 402 that functions as a management unit creates identity verification information on the passenger P based on passage history information in the passage history information DB 206a. That is, the CPU 402 creates identity verification information on the passenger P from passage history information in the temporary information DB 206b created by refining the passage history information in the passage history information DB 206a.

Further, the CPU 402 that functions as a management unit can delete as appropriate, from the identity verification information DB 406a, identity verification information on the passenger P who is no longer necessary to be subjected to identity verification in the country of interest, as described below.

For example, the CPU 402 that functions as a management unit can reference the passage history information DB 206a of the management server 20 via the network NW1 and delete, from the identity verification information DB 406a, the identity verification information on the departed passenger P for which departure from the country of interest is confirmed.

Further, for example, the CPU 402 that functions as a management unit can reference the resident qualification information DB 206d of the management server 20 via the network NW1 and delete, from the identity verification information DB 406a, the identity verification information on the passenger P whose period of stay has expired.

In such a way, it is possible to suitably delete unnecessary identity verification information from the identity verification information DB 406a. Accordingly, when the passenger P requested for identity verification information is specified, the passenger P can be accurately specified.

Further, the CPU 402 functions as a receiving unit and receives a request for identity verification for the passenger P transmitted from the facility terminal 50 via the network NW1.

Further, the CPU 402 functions as a specifying unit and specifies the passenger P requested for identity verification. When the passenger P is specified, the CPU 402 matches, at 1:N, biometric information on the passenger P transmitted along with the request for identity verification with biometric information in identity verification information on a plurality of persons in the identity verification information DB 406a. Out of the identity verification information on a plurality of persons in the identity verification information DB 406a, the CPU 402 specifies the passenger P based on identity verification information including biometric information which matches biometric information on the passenger P transmitted along with the request for identity verification.

Further the CPU 402 functions as a determination unit and determines whether or not the stay of the passenger P that has received a request for identity verification is within the period of stay. At this time, from the resident qualification information DB 206d of the management server 20, the CPU 402 acquires, resident qualification information on the passenger P for which identity verification is requested. The CPU 402 determines whether or not the stay of the passenger P is within the period of stay based on the period of stay in the acquired resident qualification information.

Note that the CPU 402 can determine whether or not the stay of the passenger P is within the period of stay based on the period of stay in the resident qualification information acquired from the resident qualification information DB 206d after matching biometric information on the passenger P for which identity verification is requested. Further, the CPU 402 may also determine whether or not the stay of the passenger P is within the period of stay based on the period of stay in the resident qualification information acquired from the resident qualification information DB 206d for the passenger P for which identity verification is requested. In such a case, if it is within the period of stay as a result of the determination, the CPU 402 can perform matching of biometric information on the passenger P.

Further, the CPU 402 performs processing of extraction of identity verification information, generation of a notification to the effect that the period of stay has expired, or the like as described later in accordance with a determination result as to whether or not it is within the period of stay.

That is, if the CPU 402 determines that it is within the period of stay, the CPU 402 functions as an extraction unit and extracts, from the identity verification information DB 406a, identity verification information including biometric information which matches biometric information on the passenger P transmitted along with the request for identity verification.

Further, if the CPU 402 determines that the period of stay has expired, the CPU 402 functions as a generation unit and generates a notification to the effect that the stay of the passenger P exceeds the period of stay. Further, when it is not possible to specify the passenger P that has received a request for identity verification by matching of biometric information and it is not possible to acquire identity verification information from the identity verification information DB 406a, the CPU 402 may determine that the stay of the passenger P exceeds the period of stay. Also in such a case, the CPU 402 can similarly generate a notification to the effect that the stay of the passenger P exceeds the period of stay. The case where it is not possible to acquire identity verification information from the identity verification information DB 406a is, for example, a case where there is no identity verification information at all that includes biometric information which matches biometric information on the passenger P transmitted along with the request for identity verification. Further, the case where it is not possible to acquire identity verification information from the identity verification information DB 406a includes, for example, a case where, while there is identity verification information including biometric information which matches biometric information on the passenger P transmitted along with the request for identity verification, the stay of the passenger P exceeds the period of stay. In such a case, the CPU 402 can delete identity verification information on the passenger P from the identity verification information DB 406a after the period of stay expires. Further, the CPU 402 can delete identity verification information on the passenger P from the identity verification information DB 406a in response to confirmation of departure of the passenger P from the country of interest.

Further, the CPU 402 functions as a transmission unit and transmits extracted identity verification information or generated response information including a notification to the effect that the period of stay has expired to the facility terminal 50 via the network NW1.

The storage device 406 is formed of a storage medium such as a nonvolatile memory, a hard disk drive, or the like and functions as a storage unit. The storage device 406 stores a program executed by the CPU 402, data referenced by the CPU 402 when executing the program, or the like.

Further, the storage device 406 stores the identity verification information DB 406a. The identity verification information described above is registered in the identity verification information DB.

The identity verification information registered in the identity verification information DB 406a includes at least passport information and biometric information out of the passage history information on the passenger P. The biometric information is biometric information included in the passage history information and a face image, for example. The biometric information is the past or the latest biometric information included in the passage history information and is preferably the latest biometric information, that is, the biometric information acquired at the entry to the country for the current stay.

Note that identity verification information may be the passage history information itself. For example, the identity verification information includes at least information equal to the information described in the identity item page of a passport. The identity verification information is information by which the staff S or the like of a facility may confirm that there is no doubt that the other party is the passenger P himself/herself in the facility in which the facility terminal 50 is installed. For example, identity verification information including a face image is displayed on a display 514 of the facility terminal 50 so that the staff S or the like of the facility can confirm the identity verification information as described later. The staff S of the facility or the like may confirm that the other party is the passenger P himself/herself by comparing the face of the other party to be subjected to identity verification with a face image included in the identity verification information displayed on the display 514 of the facility terminal 50, for example.

The communication unit 408 is connected to the network NW1 and transmits and receives data via the network NW1. The communication unit 408 communicates with the management server 20, the facility terminal 50, the mobile terminal 60, or the like under the control of the CPU 402.

The identity verification server 40 is configured in such a way.

The facility terminal 50 is a terminal that is installed in a front desk, a reception area, a cash register counter, and a window, or the like, for example, in a facility in the country of interest and is operated by the staff S of the facility. The facility in which the facility terminal 50 is installed is a facility that requires identity verification for a particular user, for example. The user to be a target person for identity verification in a facility includes a foreigner passenger P. The facility is not particularly limited and may be, for example, an accommodation facility, a shop, a commercial facility, a public facility, or the like.

As illustrated in FIG. 2, the facility terminal 50 has a CPU 502, a RAM 504, a storage device 506, a communication unit 508, a biometric information acquisition apparatus 510, an input device 512, and a display 514. The CPU 502, the RAM 504, the storage device 406, the communication unit 408, the biometric information acquisition apparatus 510, the input device 512, and the display 514 are connected to a bus line 516.

The CPU 502 functions as a control unit that operates by executing a program stored in the storage device 506 and controls the operation of the overall facility terminal 50. Further, the CPU 502 executes an application program stored in the storage device 506 and performs various processes as the terminal. The RAM 504 provides a memory area required for the operation of the CPU 502.

The CPU 502 functions as a transmission unit and transmits a request for identity verification information on the passenger P who is a target person to be subjected to identity verification to the identity verification server 40 via the network NW1. The request for identity verification information includes biometric information on the passenger P to be subjected to identity verification acquired by the biometric information acquisition apparatus 510 in order to identify and specify the passenger P to be subjected to identity verification.

Further, the CPU 502 functions as a receiving unit and receives response information to a request for identity verification information from the identity verification server 40 via the network NW1. The response information includes identity verification information or a generated notification to the effect that the period of stay has expired.

Further, the CPU 502 performs display of identity verification information on the display 514 or report to an external institute for the passenger P staying beyond the period of stay in accordance with the content of received response information. That is, the CPU 502 functions as a display control unit and displays identity verification information on the display 514 when the response information includes the identity verification information. Further, the CPU 502 functions as a report unit and performs report to an external institute when the response information includes a notification to the effect that the period of stay has expired. The case where the response information includes no identity verification information is, for example, a case where there is no identity verification information at all that includes biometric information which matches biometric information on the passenger P transmitted along with the request for identity verification. Further, the case where the response information includes no identity verification information includes, for example, a case where, while there is identity verification information including biometric information which matches biometric information on the passenger P transmitted along with the request for identity verification, the stay of the passenger P exceeds the period of stay. In such a case, the CPU 402 of the identity verification server 40 can delete identity verification information on the passenger P from the identity verification information DB 406a after the period of stay has expired, as described above. Further, the CPU 402 may delete identity verification information on the passenger P from the identity verification information DB 406a in response to confirmation of departure of the passenger P from the country of interest.

The storage device 506 is formed of a storage medium such as a nonvolatile memory, a hard disk drive, or the like and functions as a storage unit. The storage device 506 stores a program executed by the CPU 502, data referenced by the CPU 502 when executing the program, or the like.

The communication unit 508 is connected to the network NW1 and transmits and receives data via the network NW1. The communication unit 508 communicates with the identity verification server 40 or the like under the control of the CPU 502.

The biometric information acquisition apparatus 510 functions as a biometric information acquisition unit that acquires biometric information on the passenger P to be subjected to identity verification in a facility. The biometric information acquisition apparatus 510 acquires the same type of biometric information as the biometric information included in the identity verification information of the identity verification information DB 406a. The biometric information acquisition apparatus 510 is a digital camera that captures an image of the face of the passenger P, for example, and acquires a face image of the passenger P. The biometric information acquisition apparatus 510 may be configured to acquire biometric information such as a fingerprint image, an iris image, a finger vein image, a palm-print image, a palm vein image, or the like as long as it is the same type of biometric information as the biometric information included in the identity verification information.

The input device 512 is a keyboard, a mouse, or the like, for example. Further, the input device 512 may be a touch panel embedded in the display 514, for example. The input device 512 functions as an input unit that accepts input of an operation instruction from the staff S. The staff S may input various information or input an instruction for execution of a process to the facility terminal 50 via the input device 512.

The display 514 functions as a display unit that displays various windows to the staff S or the like who operate the facility terminal 50. For example, the display 514 displays an operation window used for operating the facility terminal 50 and displays an entry window used for inputting information to the facility terminal 50. Further, the display 514 displays identity verification information received from the identity verification server 40. For example, the identity verification information includes a face image as biometric information. For example, the display 514 displays identity verification information including a face image so that the staff S or the like of the facility can confirm the identity verification information. The staff S or the like of the facility may confirm that the other party is the passenger P himself/herself by comparing the face of the other party to be subjected to identity verification with a face image included in the identity verification information displayed on the display 514 of the facility terminal 50, for example.

The facility terminal 50 is configured in such a way.

The mobile terminal 60 is a terminal possessed or carried and used by the passenger P and is a mobile information device such as a smartphone, a tablet terminal, a mobile phone, or the like, for example. As illustrated in FIG. 3, the mobile terminal 60 has a CPU 602, a RAM 604, a storage device 606, a mobile communication unit 608, a short-range wireless communication unit 610, a display 612, a position sensor 614, a magnetic sensor 616, and a digital camera 618. The CPU 602, the RAM 604, the storage device 606, the mobile communication unit 608, the short-range wireless communication unit 610, the display 612, the position sensor 614, the magnetic sensor 616, and the digital camera 618 are connected to the bus line 620.

The CPU 602 functions as a control unit that operates by executing a program stored in the storage device 606 and controls the operation of the overall mobile terminal 60. Further, the CPU 602 executes an application program stored in the storage device 606 and performs various processes as the mobile information device. The RAM 604 provides a memory area required for the operation of the CPU 602.

For example, a support application that supports a procedure of the passenger P during the stay in the country of interest is installed in the storage device 606. The CPU 602 can execute the support application to perform processing related to a procedure of the passenger P during the stay. Specifically, the CPU 602 can transmit, to the identity verification server 40, permission information indicating permission of a use of passage history information intended for identity verification, as described later, for example.

Further, for example, as described in the second example embodiment, the CPU 602 may receive identity verification information from the identity verification server 40 and display the identity verification information on the display 612.

The storage device 606 is formed of a storage medium such as a nonvolatile memory, a hard disk drive, or the like and functions as a storage unit. The storage device 606 stores a program executed by the CPU 602, data referenced by the CPU 602 when executing the program, or the like. For example, the storage device 606 stores the support application described above.

The mobile communication unit 608 establishes a connection to the mobile communication network NW2 to perform wireless communication under the control of the CPU 602. The mobile communication unit 608 establishes a connection to the network NW1 via the mobile communication network NW2. The communication scheme of the mobile communication unit 608 is not particularly limited and may be, for example, a third generation mobile communication scheme, Long Term Evolution (LTE) scheme, a fourth generation mobile communication scheme, or the like.

The short-range wireless communication unit 610 wirelessly communicates with an access point, an external device, or the like under the control of the CPU 602. The communication scheme of the short-range wireless communication unit 610 is not particularly limited and may be, for example, a wireless LAN scheme such as Wi-Fi (registered trademark), a Bluetooth (registered trademark) communication scheme, a Near Field Communication (NFC) scheme, an infrared communication scheme, or the like.

The display 612 is a touch panel display that functions as a display unit having a display screen and functions as an input unit that accepts touch entry on the display screen. The display 612 displays a screen of an application program started up at the mobile terminal 60 and displays various information to the passenger P. The passenger P is able to operate an application program by touch entry on the display screen of the display 612.

The position sensor 614 measures the position of the mobile terminal 60 by using Global Navigation Satellite System (GNSS). Thereby, the position sensor 614 acquires position information indicating the position of the mobile terminal 60. The GNSS is not particularly limited and may be, for example, Global Positioning System (GPS), Global Navigation Satellite System (GLONASS), Galileo, Compass, or the like.

The magnetic sensor 616 detects terrestrial magnetism at the position of the mobile terminal 60 and acquires terrestrial magnetism information. The magnetic sensor 616 is not particularly limited and detects terrestrial magnetism by using a hall element, a magnetic resistor element, a magnetic impedance element, or the like, for example.

The digital camera 618 functions as an image capture unit and captures a subject by an image sensor to output image data.

The mobile terminal 60 is configured in such a way.

In a facility or the like used in the stay in the country of interest, the passenger P who is a foreigner not having the nationality of the country of interest may be asked for identity verification with a certificate or the like issued by a public institute such as a passport. However, if a passenger has to possess or carry a certificate such as a passport or a substitute thereof for identity verification, this lacks usability because such a certificate or the like may be lost or stolen and, in addition, identity verification is unable to be made in a case of non-possession of such a certificate or the like.

In contrast, the identity verification system 1 according to the present example embodiment performs identity verification by creating identity verification information based on passage history information in the passage history information DB 206a and transmitting the created identity verification information to the facility terminal 50. More specifically, the identity verification server 40 references the temporary information DB 206b created by refining the passage history information in the passage history information DB 206a based on passenger information related to the passenger P. Thereby, the identity verification server 40 creates identity verification information on the passenger P from the passage history information in the temporary information DB 206b. In the facility terminal 50, identity verification of the passenger P who is the target person is performed based on the identity verification information transmitted from the identity verification server 40.

Thus, according to the identity verification system 1 of the present example embodiment, the foreigner passenger P who is a target person to be subjected to identity verification is not required to present a certificate or the like such as a passport in the identity verification. Therefore, the identity verification system 1 according to the present example embodiment does not require a passenger to possess or carry a certificate or a substitute thereof and can perform identity verification with high usability.

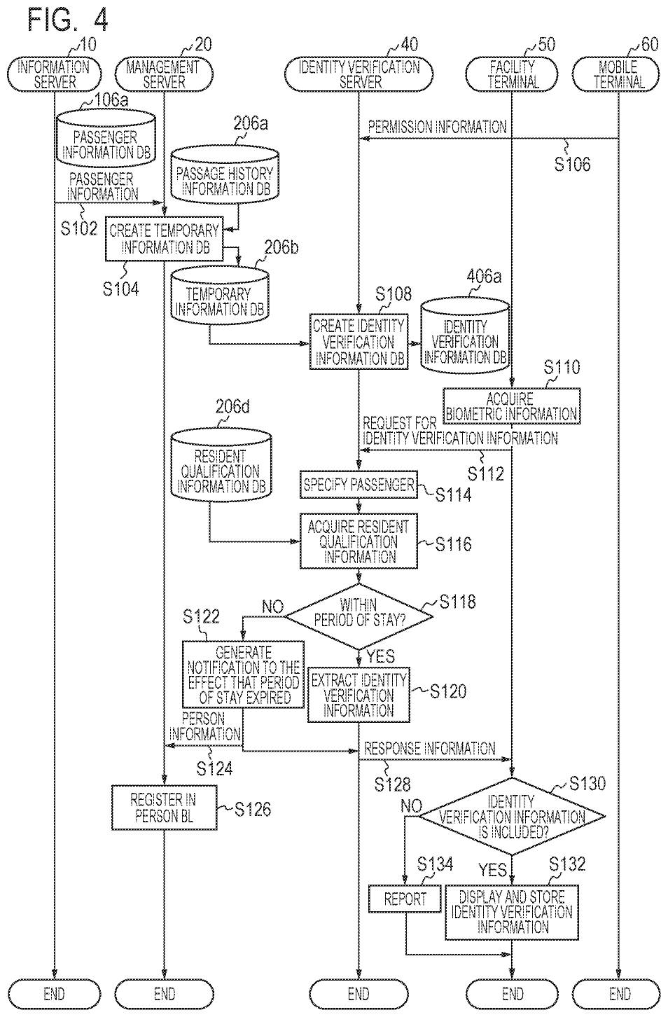

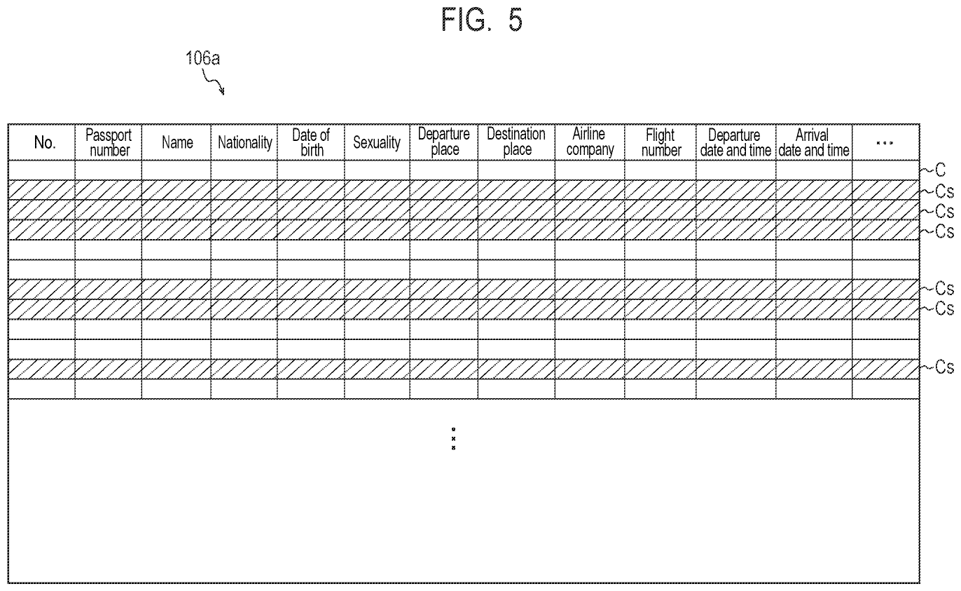

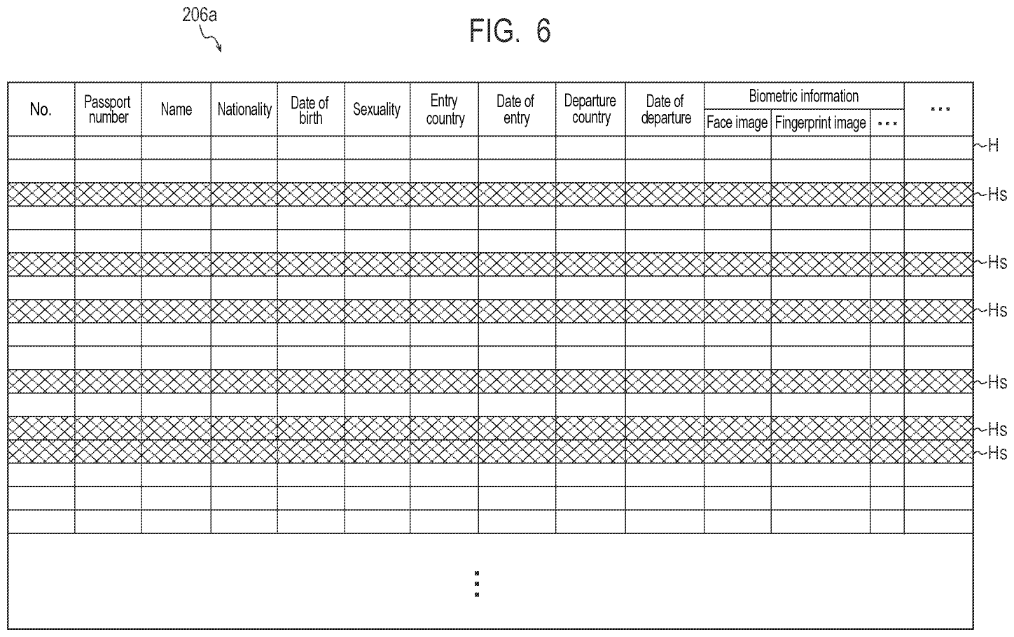

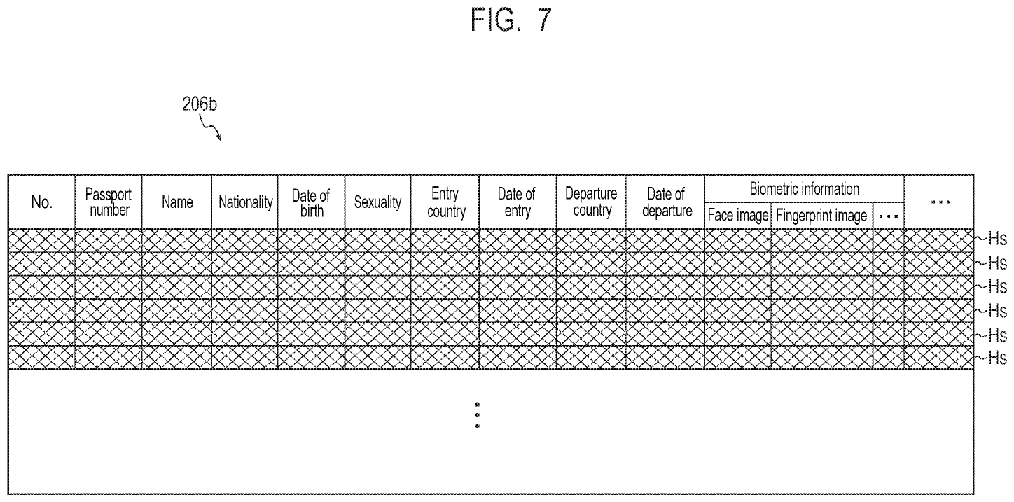

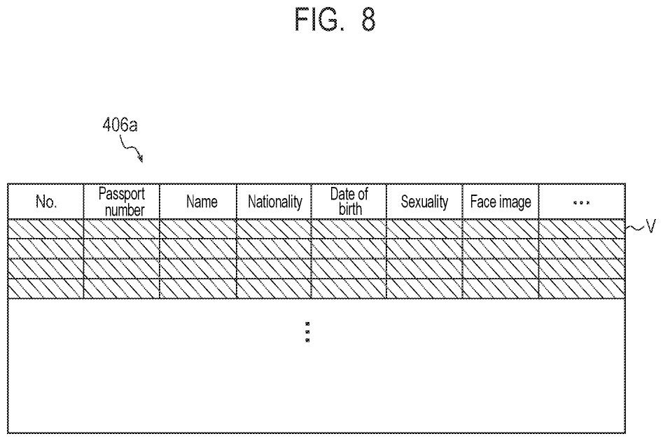

The identity verification operation in the identity verification system 1 according to the present example embodiment will be further described below with reference to FIG. 4 to FIG. 8. FIG. 4 is a sequence diagram illustrating the operation of the information server 10, the management server 20, the identity verification server 40, the facility terminal 50, and the mobile terminal 60 in the identity verification system 1 according to the present example embodiment. FIG. 5 is a schematic diagram illustrating an example of the passenger information DB 106a of the information server 10 according to the present example embodiment. FIG. 6 is a schematic diagram illustrating an example of the passage history information DB 206a of the management server 20 according to the present example embodiment. FIG. 7 is a schematic diagram illustrating an example of the temporary information DB 206b of the management server 20 according to the present example embodiment. FIG. 8 is a schematic diagram illustrating an example of the identity verification information DB 406a of the identity verification server 40 according to the present example embodiment. Note that in each of the DBs 106a, 206a, 206c, and 406a illustrated in FIG. 5 to FIG. 8, data of each item is omitted for simplified illustration. When the identity verification operation in the identity verification system 1 according to the present example embodiment is performed, the information providing method according to the present example embodiment is performed.

As illustrated in FIG. 4, the CPU 102 of the information server 10 regularly or irregularly transmits and provides passenger information registered in the passenger information DB 106a to the management server 20 via the network NW1 in advance (step S102).

The passenger information is transmitted and reported in advance to the information server 10 from the company server 30 of each airline company for the country of interest via the network NW1. The CPU 102 of the information server 10 aggregates and registers the passenger information, which has been reported in advance, in the passenger information DB 106a of the storage device 206. As illustrated in FIG. 5 as an example, pieces of passenger information C on a plurality of passengers P reported in advance from the company server 30 of each airline company are registered and managed in the passenger information DB 106a. Note that passenger information Cs of the passenger information C is the passenger information C which satisfies a particular condition described below. The CPU 102 provides the passenger information C of the passenger information DB 106a to the management server 20 in advance.

The CPU 202 of the management server 20 refines passage history information registered in the passage history information DB 206a based on the passenger information provided in advance from the information server 10. Thereby, the CPU 202 creates the temporary information DB 206b (step S104). In the temporary information DB 206b, compared to the passage history information in the passage history information DB 206a, refined and reduced number of pieces of passage history information are registered. The CPU 202 can refine the passage history information in the passage history information DB 206a to create the temporary information DB 206b based on passenger information as described below, for example.

For example, first, out of the passenger information provided in advance from the information server 10, the CPU 202 extracts particular passenger information which satisfies a particular condition, specifically, particular passenger information in which the arrival date and time is included in a predetermined period in which matching for identity verification is performed at an inspection booth or an automated gate. The arrival date and time may instead be the arrival date. The predetermined period may be, for example, a unit of day or a unit of hour. As illustrated in FIG. 5, the CPU 202 extracts the passenger information Cs which satisfies the particular condition out of the passenger information C in the passenger information DB 106a provided in advance. Further, the CPU 202 may extract particular passenger information based on a departure date and time or a departure date as a reference instead of extracting particular passenger information based on an arrival date and time or an arrival date as a reference.

Subsequently, the CPU 202 extracts, from passage history information in the passage history information DB 206a, particular passage history information associated with personal identification information on the passenger P included in the extracted particular passenger information. That is, the CPU 202 extracts particular passage history information corresponding to the extracted particular passenger information from passage history information in the passage history information DB 206a. As illustrated in FIG. 6 as an example, in the passage history information DB 206a, pieces of passage history information H on a plurality of passengers P who made immigration in the past are registered and managed. As illustrated in FIG. 6, the CPU 202 extracts particular passage history information Hs associated with personal identification information on the passenger P included in the particular passenger information Cs out of the passage history information H in the passage history information DB 206a.

Subsequently, the CPU 202 registers the extracted particular passage history information in a database to create the temporary information DB 206b. As illustrated in FIG. 7 as an example, the extracted particular passage history information Hs is registered as the matching-use passage history information in the temporary information DB 206b.

Further, the CPU 202 can use another condition as the following condition as a particular condition to be satisfied by particular passenger information instead of the condition described above or in addition to the condition described above.

For example, first, the CPU 202 extracts particular passenger information which satisfies a particular condition, specifically, particular passenger information including a particular arrival place to be matched for identity verification at the inspection booth or the automated gate out of the passenger information provided in advance from the information server 10. The particular arrival place may be a particular airport or may be a group of particular airports.

Subsequently, the CPU 202 extracts, from passage history information in the passage history information DB 206a, particular passage history information associated with personal identification information on the passenger P included in the extracted particular passenger information in the same manner as the case described above. Subsequently, the CPU 202 registers the extracted particular passage history information in a database to create the temporary information DB 206b.

In such a way, the CPU 202 of the management server 20 refines passage history information in the passage history information DB 206a to create the temporary information DB 206b. Note that the CPU 202 updates the temporary information DB 206b as needed. The biometric information included in the passage history information of the temporary information DB 206b is used for matching of biometric information used for identity verification in entry inspection at the inspection booth or the automated gate.

On the other hand, the passenger P who permits a use of passage history information intended for identity verification transmits in advance permission information indicating permission of a use of passage history information from the mobile terminal 60 to the identity verification server 40. Thus, for example, the CPU 602 of the mobile terminal 60 transmits permission information to the identity verification server 40 via the mobile communication network NW2 and the network NW1 in accordance with an instruction input from the passenger P (step S106). The permission information includes personal identification information on the passenger P. The personal identification information on the passenger P is not particularly limited and is a passport number, for example. Further, the personal identification information may be, for example, a combination of two or more pieces of identity information such as a name, a nationality, a date of birth, or the like.

The passenger P transmits permission information in advance before involved in a situation where identity verification is asked and may transmit permission information in advance at a timing before entry to the country of interest, before entry inspection after a passage to the country of interest, or the like, for example.

Further, the passenger P is not necessarily required to transmit permission information from the mobile terminal 60 possessed or carried by the passenger P and may transmit permission information from another terminal connected to the network NW1. For example, the passenger P may transmit permission information from a terminal installed at a home, a workplace, or the like. Further, the permission information may be transmitted to the identity verification server 40 not only from a terminal usually used by the passenger P but also from the facility terminal 50 in a facility requesting for identity verification, for example.

The CPU 402 of the identity verification server 40 creates, from the temporary information DB 206b of the management server 20, the identity verification information DB 406a in which identity verification information on the passenger P who has transmitted the permission information is registered (step S108).

To create the identity verification information DB 406a, first, the CPU 402 references the temporary information DB 206b of the management server 20 via the network NW1. Subsequently, the CPU 402 extracts, from the temporary information DB 206b, passage history information associated with personal identification information on the passenger P who has transmitted the permission information.

Subsequently, the CPU 402 creates identity verification information on the passenger P from the extracted passage history information. For example, the CPU 402 creates identity verification information including at least passport information and biometric information in the passage history information. The passport information in identity verification information includes passport description items such as a passport number, a name, a nationality, a date of birth, a sexuality, or the like. Further, the biometric information is a face image, for example.

In such a way, the CPU 402 creates identity verification information from various passage history information on the temporary information DB 206b created in accordance with various particular conditions and accumulates the identity verification information. Subsequently, the CPU 402 registers the accumulated identity verification information in a database to create the identity verification information DB 406a. As illustrated in FIG. 8 as an example, identity verification information V including at least passport information and a face image that is biometric information out of the passage history information Hs illustrated in FIG. 7 is registered and managed in the identity verification information DB 406a.

Note that the CPU 402 can also create the identity verification information DB 406a by using passage history information extracted from the temporary information DB 206b directly as identity verification information.

Further, the CPU 402 can also create identity verification information based on a date of entry to the country, a period of stay, or the like of the passenger P. For example, the CPU 402 can extract passage history information on the passenger P in which the date of entry to the country is a particular date to create identity verification information in the same manner as above. Further, for example, the CPU 402 can extract passage history information on the passenger P whose period of stay is within a particular period and create identity verification information in the same manner as described above. In such a case, the CPU 402 can acquire a date of entry to the country of the passenger P from the passage history information DB 206a of the management server 20. Further, the CPU 402 can acquire a period of stay of the passenger P from the resident qualification information DB of the management server 20.

The identity verification information of the identity verification information DB 406a to be created is identity verification information related to the passenger P who has entered the country of interest after entry inspection and is staying in the country of interest, which is the passenger P whose period of stay has not yet expired or who has not yet departed from the country. The CPU 402 can delete identity verification information on the passenger P after the period of stay expires based on the period of stay included in the resident qualification information on the resident qualification information DB of the management server 20. Further, the CPU 402 may delete identity verification information on the passenger P after departure of the country based on the date of departure included in the passage history information in the passage history information DB 206a of the management server 20.

The CPU 402 of the identity verification server 40 creates the identity verification information DB 406a from the temporary information DB 206b in such a way. Note that the CPU 402 updates the identity verification information DB 406a as needed.

Note that the identity verification information in the identity verification information DB 406a is not necessarily required to be created from the passage history information in the temporary information DB 206b. For example, the CPU 402 can also reference the passage history information DB 206a of the management server 20 to create identity verification information from the passage history information in the passage history information DB 206a without via the temporary information DB 206b. In such a case, the CPU 402 can create identity verification information related to the passenger P from the passage history information on the passage history information DB 206a based on the latest passage history information or information related to entry inspection, for example. The passenger P whose identity verification information is created in such a way is a passenger who has entered the country of interest after entry inspection and is staying in the country of interest, which is the passenger whose period of stay has not yet expired or who has not yet departed from the country.

On the other hand, in the facility in which identity verification of the passenger P is performed, biometric information on the passenger P who is a target person to be subjected to identity verification is acquired by the biometric information acquisition apparatus 510 of the facility terminal 50 in accordance with an operation by the staff S (step S110). The acquired biometric information is a face image, for example. Note that the acquired biometric information may be the same type of biometric information as the biometric information included in identity verification information other than a face image.

Next, the CPU 502 of the facility terminal 50 transmits a request for identity verification information on the passenger P who is a target person to be subjected to identity verification via the network NW1 to the identity verification server 40 in which the identity verification information DB 406a has been created (step S112). At this time, the CPU 502 transmits biometric information on the passenger P acquired by the biometric information acquisition apparatus 510 to the identity verification server 40 via the network NW1 along with the request for identity verification information.

In response to receiving the request for identity verification information from the facility terminal 50, the CPU 402 of the identity verification server 40 matches, at 1:N, the biometric information transmitted along with the request for identity verification with biometric information in the identity verification information DB 406a. Thereby, the CPU 402 specifies the passenger P who is the target person to be subjected to identity verification (step S114). At this time, out of the identity verification information on a plurality of persons in the identity verification information DB 406a, the CPU 402 specifies the passenger P based on the identity verification information including biometric information which matches the biometric information on the passenger P transmitted along with a request for identity verification.

Next, the CPU 402 references the resident qualification information DB 206d of the management server 20 via the network NW1. Thereby, the CPU 402 acquires resident qualification information on the specified passenger P from the resident qualification information DB 206d based on personal identification information such as a passport number included in the identity verification information of the specified passenger P (step S116).

Next, the CPU 402 determines whether or not the current stay of the specified passenger P is within the period of stay based on the acquired resident qualification information (step S118).

If the CPU 402 determines that it is within the period of stay (step S118, YES), the CPU 402 extracts the identity verification information of the specified passenger P from the identity verification information DB 406a (step S120). That is, the CPU 402 extracts, from the identity verification information DB 406a, the identity verification information including biometric information which matches the biometric information of the passenger P transmitted along with the request for identity verification.

Note that the CPU 402 can also determine whether or not the stay of the passenger P is within the period of stay based on the period of stay in the resident qualification information acquired from the resident qualification information DB 206d for the passenger P asked for identity verification. In such a case, if it is within the period of stay as a result of the determination, the CPU 402 can perform matching of biometric information on the passenger P.

On the other hand, if the CPU 402 determines that the period of stay has expired (step S118, NO), the CPU 402 generates a notification to the effect that the current stay of the specified passenger P exceeds the period of stay (step S122).

Furthermore, if the CPU 402 determines that the period of stay has expired, the CPU 402 transmits person information on the specified passenger P to the management server 20 via the network NW1 (step S124). The person information includes the passport information on the specified passenger P, biometric information acquired by the biometric information acquisition apparatus 510 of the facility terminal 50, or the like.

In response to receiving person information from the identity verification server 40, the CPU 202 of the management server 20 registers the person information in the watch list in the person list DB 206c (step S126). In such a way, the person information on the passenger P whose current stay exceeds the period of stay is registered in the watch list.

The CPU 402 of the identity verification server 40 transmits response information as a response to the request for identity verification information to the facility terminal 50 via the network NW1 after step S120 or step S122 (step S128). The response information includes the identity verification information extracted in step S120 or the notification generated in step S122.

In response to receiving the response information from the identity verification server 40, the CPU 502 of the facility terminal 50 determines whether or not the response information includes identity verification information (step S130). The case where the response information includes no identity verification information is, for example, a case where there is no identity verification information at all that includes biometric information which matches biometric information on the passenger P transmitted along with the request for identity verification. Further, the case where the response information includes no identity verification information includes, for example, a case where, while there is identity verification information including biometric information which matches biometric information on the passenger P transmitted along with the request for identity verification, the stay of the passenger P exceeds the period of stay. In such a case, the CPU 402 of the identity verification server 40 can delete identity verification information on the passenger P from the identity verification information DB 406a after the period of stay expires, as described above. Further, the CPU 402 may delete identity verification information on the passenger P from the identity verification information DB 406a in response to confirmation of departure of the passenger P from the country of interest.

If the CPU 502 determines that identity verification information is included (step S130, YES), the CPU 502 displays the identity verification information included in the response information on the display 514 and stores the identity verification information in the storage device 506 (step S132). The CPU 502 displays passport information and biometric information included in the identity verification information the display 514.

The staff S of the facility may perform identity verification of the passenger P based on the passport information and the biometric information displayed on the display 514. For example, the staff S or the like of the facility may confirm that the other party is the passenger P himself/herself by comparing the face of the other party to be subjected to identity verification with a face image included in the identity verification information displayed on the display 514 of the facility terminal 50. Further, the identity verification information can be stored in the storage device 506 together with date and time information indicating a date and time when identity verification was performed. By storing identity verification information together with date and time information in the storage device 506, it is possible to store a history of identity verification performed in the facility.

On the other hand, if the CPU 502 determines that no identity verification information is included (step S130, NO), the CPU 502 transmits a report to the effect that the passenger P whose stay exceeds the period of stay is present in the facility to the external institute via the network NW1 (step S134). At this time, the CPU 502 includes position information indicating the location of the facility, date and time information indicating the date and time when the identity verification was performed, or the like in the report and transmits the report to the external institute via the network NW1. The position information indicating the location of the facility is position information that specifies the position of the passenger P who is the target person. The external institute is an institute that cracks down on illegal immigration, such as an administration office that manages departure from and entry to the country, police, or the like, for example. In such a case, the passenger P who performs identity verification has stayed beyond the period of stay included in the resident qualification information and thus is likely to be an illegal immigrant. Thus, a process of transmitting a report to the external institute is performed. Further, in such a case, the CPU 502 displays a notification to the effect that the current stay of the passenger P included in the response information exceeds the period of stay on the display 514.

Further, the CPU 502 can receive a result of matching of the passenger P with the watch list performed by the management server 20 or the like, for example, via the NW1. Also when the passenger P corresponds to a person registered in the watch list, the CPU 502 can transmit, to the external institute via the network NW1, a report to the effect that the passenger P is present in the facility in the same manner as the case of the passenger P whose stay exceeds the period of stay as described above.

In such a way, the CPU 502 performs a process on the passenger P who is a target person to be subjected to identity verification in accordance with the content of the response information transmitted from the identity verification server 40.

As described above, in the present example embodiment, identity verification of the passenger P is performed in accordance with identity verification information transmitted from the identity verification server 40 to the facility terminal 50. Therefore, according to the present example embodiment, identity verification can be performed with high usability without requiring a passenger P to possess or carry a certificate such as a passport or a substitute thereof.

### Second Example Embodiment

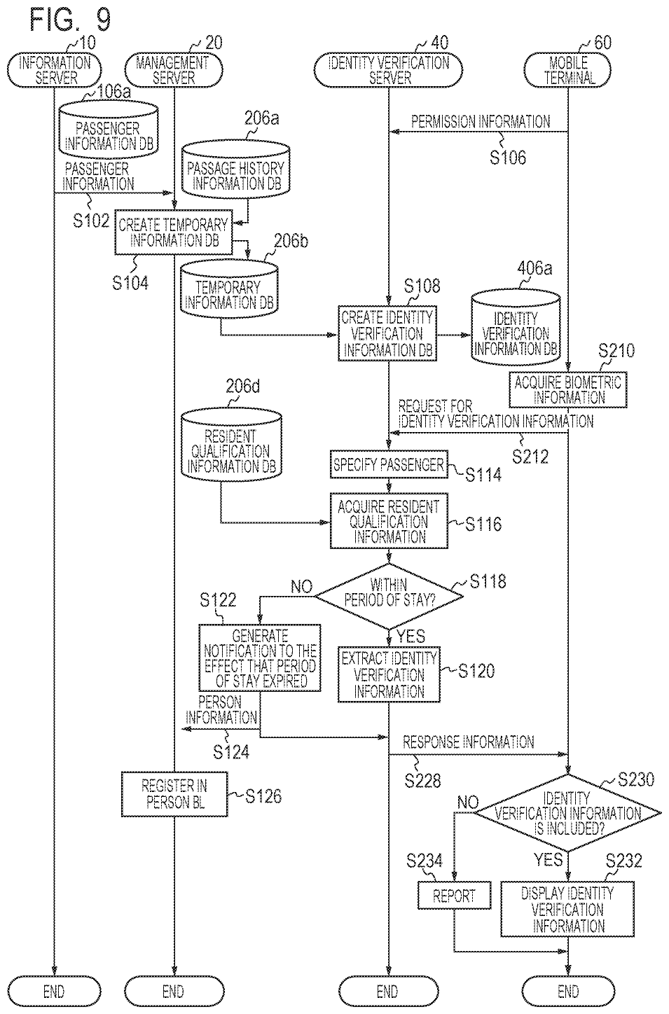

An information providing apparatus, a terminal, an identity verification system, and an information providing method according to a second example embodiment of the present invention will be described with reference to FIG. 9. Note that the same components as those of the information providing apparatus, the terminal, the identity verification system, and the information providing method according to the first example embodiment described above are labeled with the same references, and the description thereof will be omitted or simplified.

Although the case of transmitting identity verification information on the passenger P to the facility terminal 50 has been described in the above example embodiment, the example embodiment is not limited thereto. In the present example embodiment, a case of transmitting identity verification information on the passenger P to the mobile terminal 60 possessed or carried by the passenger P who is a target person to be subjected to identity verification will be described. Note that the configuration of the identity verification system 1 according to the present example embodiment is the same as the configuration of the identity verification system 1 according to the first example embodiment illustrated in FIG. 1 to FIG. 3.

In the present example embodiment, the biometric information on the passenger P is acquired at the mobile terminal 60 of the passenger P to be subjected to identity verification. For example, the digital camera 618 of the mobile terminal 60 captures an image of the face of the passenger P to be subjected to identity verification and acquires a face image as biometric information on the passenger P. Further, for example, the digital camera 618 can also capture an iris of the passenger P to acquire an iris image as biometric information on the passenger P. The mobile terminal 60 can be configured to have a biometric information acquisition unit that acquires the same type of biometric information as the biometric information included in the identity verification information other than a face image or the like.

Further, the CPU 602 of the mobile terminal 60 functions as a transmission unit and transmits a request for identity verification information on the passenger P to be subjected to identity verification to the identity verification server 40 via the mobile communication network NW2 and the network NW1. The request for identity verification information includes biometric information on the passenger P to be subjected to identity verification, specifically, a face image of the passenger P acquired by the digital camera 618, for example, in order to identify the passenger P to be subjected to identity verification.

Further, the CPU 602 functions as a receiving unit and receives response information to a request for identity verification information from the identity verification server 40 via the network NW1 and the mobile communication network NW2. The response information includes identity verification information or a generated notification to the effect that the period of stay has expired.

Further, the CPU 602 performs display of identity verification information on the display 612 or performs notification to the passenger P to the effect that the period of stay has expired or report to an external institute for the passenger P staying beyond the period of stay in accordance with the content of received response information. That is, the CPU 602 functions as a display control unit and displays identity verification information on the display 612 when the response information includes the identity verification information. Further, the CPU 602 functions as a notification unit and, when the response information includes a notification to the effect that the period of stay has expired, displays the notification on the display 612 to notify the passenger P. Further, the CPU 602 functions as a report unit and performs report to an external institute when the response information includes a notification to the effect that the period of stay has expired.

The display 612 displays identity verification information or the like received from the identity verification server 40.

The identity verification server 40 operates in the same manner as the case of the first example embodiment except for transmitting and receiving information to and from the mobile terminal 60 instead of transmitting and receiving information to and from the facility terminal 50.

That is, the CPU 402 of the identity verification server 40 functions as a receiving unit and receives a request for identity verification for the passenger P transmitted from the mobile terminal 60 via the mobile communication network NW2 and the network NW1.

Further, the CPU 402 functions as a transmission unit and transmits extracted identity verification information or generated response information including a notification to the effect that the period of stay has expired to the mobile terminal 60 via the network NW1 and the mobile communication network NW2.

The identity verification operation in the identity verification system 1 according to the present example embodiment will be further described below with reference to FIG. 9. FIG. 9 is a sequence diagram illustrating the operation of the information server 10, the management server 20, the identity verification server 40, and the mobile terminal 60 in the identity verification system 1 according to the present example embodiment. When the identity verification operation in the identity verification system 1 according to the present example embodiment is performed, the information providing method according to the present example embodiment is performed.

Also, in the present example embodiment, the same process from step S106 to step S108 as in the first example embodiment is performed as illustrated in FIG. 11.

In a facility in which identity verification of the passenger P is performed, the passenger P to be subjected to identity verification operates the mobile terminal 60 by himself/herself to capture an image of the face of the passenger P by using the digital camera 618 by himself/herself. Thereby, the digital camera 618 acquires a face image as biometric information on the passenger P (step S210).

Next, the CPU 602 of the mobile terminal 60 transmits the request for identity verification information of the passenger P to be subjected to identity verification to the identity verification server 40 in which the identity verification information DB 406a has been created via the mobile communication network NW2 and the network NW1 (step S212). At this time, the CPU 602 transmits the face image that is biometric information on the passenger P acquired by the digital camera 618 to the identity verification server 40 together with the request for identity verification information via the mobile communication network NW2 and the network NW1.

In response to receiving the request for identity verification information from the mobile terminal 60, the CPU 402 of the identity verification server 40 matches, at 1:N, the face image transmitted along with the request for identity verification with face images in the identity verification information DB 406a. Thereby, the CPU 402 specifies the passenger P to be subjected to identity verification (step S114). At this time, out of the identity verification information on a plurality of persons in the identity verification information DB 406a, the CPU 402 specifies the passenger P based on the identity verification information including the face image which matches the face image of the passenger P transmitted along with the request for identity verification.

After step S114, the same process of steps S116, S118, and S120 as in the first example embodiment or the same process of steps S116, S118, S122, S124, and S126 as in the first example embodiment is performed.

After step S120 or step S122, the CPU 402 of the identity verification server 40 transmits response information to the mobile terminal 60 as a response to the request for identity verification information via the network NW1 and the mobile communication network NW2 (step S228). The response information includes the identity verification information extracted in step S120 or the notification generated in step S122. The mobile terminal 60 to which the response information is transmitted is a terminal which has transmitted permission information indicating permission of a use of passage history information intended for identity verification.

In response to receiving the response information from the identity verification server 40, the CPU 602 of the mobile terminal 60 determines whether or not the response information includes identity verification information (step S230).

If the CPU 602 determines that identity verification information is included (step S230, YES), the CPU 602 displays the identity verification information on the display 612 (step S232). The CPU 602 displays passport information and a face image included in the identity verification information on the display 612.

The passenger P who possesses or carries the mobile terminal 60 presents the display 612 on which the passport information and the biometric information are displayed to the staff S of the facility. The staff S may check the window of the display 612 presented by the passenger P to perform identity verification of the passenger P based on the passport information and the face image displayed on the display 612.

Note that the CPU 602 may only temporarily store the identity verification information included in the response information in the RAM 604 or the like or store the identity verification information in the storage device 606. When identity verification information is stored in the storage device 606, it is possible to display the identity verification information stored in the storage device 606 on the display 612 to quickly perform identity verification without via communication with the identity verification server 40 after the storage.

On the other hand, if the CPU 602 determines that no identity verification information is included (step S230, NO), the CPU 602 transmits a report to the effect that the passenger P whose stay exceeds the period of stay is present in the facility to the external institute via the mobile communication network NW2 and the network NW1 (step S234). At this time, the CPU 602 includes position information indicating the position of the mobile terminal 60 acquired by the position sensor 614 and date and time information indicating the date and time when the identity verification was performed or the like in the report and transmits the report to the external institute via the mobile communication network NW2 and the network NW1. The position information indicating the position of the mobile terminal 60 is position information that specifies the position of the passenger P who is a target person. The position information indicating the position of the mobile terminal 60 may be position information based on terrestrial magnetism information acquired by the magnetic sensor 616. The external institute is the same as that in the first example embodiment.

Further, the CPU 602 can also display a notification to the effect that the current stay of the passenger P exceeds the period of stay on the display 612 in addition to or instead of the report to the external institute. The passenger P is able to know that his/her stay exceeds the period of stay from the notification displayed on the display 612 and may take an action in accordance with the situation such as appearing to a government office or the like.

In such a way, the CPU 602 performs a process on the passenger P to be subjected to identity verification in accordance with the content of the response information transmitted from the identity verification server 40.

As described above, in the present example embodiment, identity verification of the passenger P is performed in accordance with identity verification information transmitted from the identity verification server 40 to the mobile terminal 60. Therefore, according to the present example embodiment, identity verification can be performed with high usability without requiring a passenger to possess or carry a certificate such as a passport.

Further, in the present example embodiment, since identity verification information is transmitted from the identity verification server 40 to the mobile terminal 60, it is not necessary to store identity verification information all the time in the mobile terminal 60. Therefore, according to the present example embodiment, it is possible to avoid leakage of identity verification information from the mobile terminal 60 due to loss, theft, or the like of the mobile terminal 60, and it is therefore possible to ensure high security.

### Another Example Embodiment

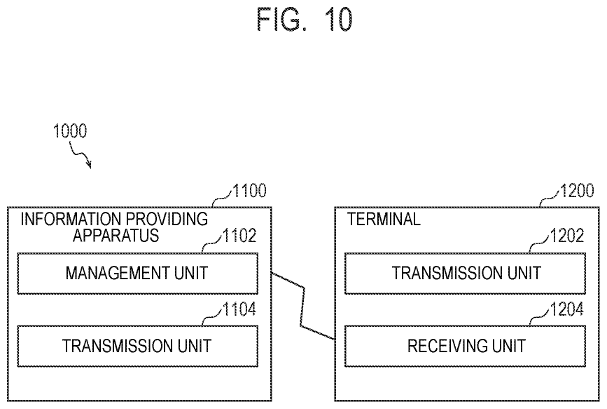

The identity verification system described in the above example embodiment may be configured as illustrated in FIG. 10 according to another example embodiment. FIG. 10 is a block diagram illustrating a configuration of an identity verification system according to another example embodiment.

As illustrated in FIG. 10, an identity verification system 1000 according to another example embodiment includes an information providing apparatus 1100 and a terminal 1200 capable of communication with the information providing apparatus 1100.

The information providing apparatus 1100 has a management unit 1102 that creates identity verification information on a passenger based on passage history information including biometric information on the passenger. Further, the information providing apparatus 1100 has a transmission unit 1104 that transmits the identity verification information including biometric information which matches biometric information on a target person in response to receiving a request for the biometric information and the identity verification information on the target person.

The terminal 1200 has a transmission unit 1202 that transmits a request for biometric information and identity verification information on a target person to an information providing apparatus and a receiving unit 1204 that receives a response to the request from the information providing apparatus 1100.

According to another example embodiment, identity verification information on a passenger created based on passage history information is transmitted. Therefore, according to the present example embodiment, identity verification can be performed with high usability without requiring a passenger to possess or carry a certificate or a substitute thereof.

### Modified Example Embodiments

The present invention is not limited to the example embodiments described above, and various modifications are possible.

For example, although the case where the information server 10, the management server 20, and the identity verification server 40 are separate servers has been described as an example in the above example embodiments, the example embodiment is not limited thereto. A single server may be configured to function as all or at least any two of the information server 10, the management server 20, and the identity verification server 40.

Further, although the case where identity verification information is created from passage history information in the temporary information DB 206b refined from the passage history information DB 206a of the management server 20 has been described as an example in the above example embodiments, the example embodiment is not limited thereto. For example, the CPU 402 of the identity verification server 40 may reference the passage history information DB 206a of the management server 20 to create identity verification information on the passenger P in the same manner as in the above example embodiments from the passage history information of the passage history information DB 206a. That is, the CPU 402 can directly create identity verification information on the passenger P from the passage history information in the passage history information DB 206a.

Further, although the case where identity verification information is created from passage history information on the passenger P who has permitted a use of passage history information intended for identity verification has been described as an example in the above example embodiments, the example embodiment is not limited thereto. For example, identity verification information may be created from passage history information on the passenger P regardless of whether or not a use of passage history information intended for identity verification is permitted.

Further, the scope of each of the example embodiments includes a processing method that stores, in a storage medium, a program that causes the configuration of each of the example embodiments to operate so as to implement the function of each of the example embodiments described above, reads the program stored in the storage medium as a code, and executes the program in a computer. That is, the scope of each of the example embodiments also includes a computer readable storage medium. Further, each of the example embodiments includes not only the storage medium in which the computer program described above is stored but also the computer program itself.

As the storage medium, for example, a floppy (registered trademark) disk, a hard disk, an optical disk, a magneto-optical disk, a compact disk-read only memory (CD-ROM), a magnetic tape, a nonvolatile memory card, or a ROM can be used. Further, the scope of each of the example embodiments includes an example that operates on operating system (OS) to perform a process in cooperation with another software or a function of an add-in board without being limited to an example that performs a process by an individual program stored in the storage medium.

The whole or part of the example embodiments disclosed above can be described as, but not limited to, the following supplementary notes.

(Supplementary Note 1)

An information providing apparatus comprising:

a management unit that creates identity verification information on a passenger based on passage history information including biometric information on the passenger; and

a transmission unit that, in response to receiving biometric information on a target person and a request for the identity verification information, transmits the identity verification information including the biometric information that matches the biometric information on the target person.

(Supplementary Note 2)

The information providing apparatus according to supplementary note 1, wherein the transmission unit transmits the identity verification information including the biometric information that matches the biometric information on the target person to a terminal that transmitted the biometric information on the target person and the request for the identity verification information.

(Supplementary Note 3)

The information providing apparatus according to supplementary note 1 or 2, wherein the management unit creates the identity verification information on the passenger based on passenger information and the passage history information related to the passenger.

(Supplementary Note 4)

The information providing apparatus according to any one of supplementary notes 1 to 3, wherein the management unit creates identity verification information on the passenger corresponding to the passenger information from the passage history information extracted based on the passenger information related to the passenger.

(Supplementary Note 5)

The information providing apparatus according to any one of supplementary notes 1 to 4, wherein the management unit creates the identity verification information based on a date of entry to a country or a period of stay of the passenger.

(Supplementary Note 6)

The information providing apparatus according to any one of supplementary notes 1 to 5, wherein the management unit creates the identity verification information on the passenger based on the latest passage history information related to the passenger.

(Supplementary Note 7)

The information providing apparatus according to any one of supplementary notes 1 to 6, wherein the management unit deletes the identity verification information related to the passenger after the passenger departs from a country or after a period of stay expires.

(Supplementary Note 8)

The information providing apparatus according to any one of supplementary notes 1 to 7, wherein the management unit creates the identity verification information for the passenger who permitted a use of the passage history information intended for identity verification.

(Supplementary Note 9)

The information providing apparatus according to any one of supplementary notes 1 to 7, wherein the management unit transmits the identity verification information including the biometric information that matches the biometric information on the target person to a terminal that transmitted permission information indicating permission of a use of the passage history information intended for identity verification.

(Supplementary Note 10)

A terminal configured to communicate with an information providing apparatus, wherein the information providing apparatus includes

a management unit that creates identity verification information on a passenger based on passage history information including biometric information on the passenger, and

a transmission unit that, in response to receiving biometric information on a target person and a request for the identity verification information, transmits the identity verification information including the biometric information that matches the biometric information on the target person,

the terminal comprising:

a transmission unit that transmits the biometric information on the target person and the request for the identity verification information to the information providing apparatus; and a receiving unit that receives a response to the request from the information providing apparatus.

(Supplementary Note 11)

The terminal according to supplementary note 10 further comprising a report unit that externally transmits position information that specifies a position of the target person when the identity verification information is not included in the response.

(Supplementary Note 12)

The terminal according to supplementary note 10 or 11, wherein the terminal is a terminal installed in a facility in which identity verification of the target person is performed or a terminal possessed or carried by the target person.

(Supplementary Note 13)

An identity verification system comprising: an information providing apparatus; and a terminal configured to communicate with the information providing apparatus,

wherein the information providing apparatus includes

a management unit that creates identity verification information on a passenger based on passage history information including biometric information on the passenger, and

a transmission unit that, in response to receiving biometric information on a target person and a request for the identity verification information, transmits the identity verification information including the biometric information that matches the biometric information on the target person, and

wherein the terminal includes

a transmission unit that transmits the biometric information on the target person and the request for the identity verification information to the information providing apparatus, and

a receiving unit that receives a response to the request from the information providing apparatus.

(Supplementary Note 14)

An information providing method comprising:

creating identity verification information on a passenger based on passage history information including biometric information on the passenger; and

in response to receiving biometric information on a target person and a request for the identity verification information, transmitting the identity verification information including the biometric information that matches the biometric information on the target person.

(Supplementary Note 15)

A storage medium storing a program that causes a computer to perform:

creating identity verification information on a passenger based on passage history information including biometric information on the passenger; and

in response to receiving biometric information on a target person and a request for the identity verification information, transmitting the identity verification information including the biometric information that matches the biometric information on the target person.

As described above, while the present invention has been described with reference to the example embodiments, the present invention is not limited to these example embodiments described above. Various modifications that can be understood by those skilled in the art can be made to the configuration and details of the present invention within the scope of the present invention.

This application is based upon and claims the benefit of priority from Japanese Patent Application No. 2018-097942, filed on May 22, 2018, the disclosure of which is incorporated herein in its entirety by reference.

### REFERENCE SIGNS LIST

1 identity verification system
10 information server
20 management server
30 company server
40 identity verification server
50 facility terminal
60 mobile terminal
NW1 network
NW2 mobile communication network

1. An information providing apparatus comprising:
a management unit that creates identity verification information on a passenger based on passage history information including biometric information on the passenger; and
a transmission unit that, in response to receiving biometric information on a target person and a request for the identity verification information, transmits the identity verification information including the biometric information that matches the biometric information on the target person.

2. The information providing apparatus according to claim 1, wherein the transmission unit transmits the identity verification information including the biometric information that matches the biometric information on the target person to a terminal that transmitted the biometric information on the target person and the request for the identity verification information.

3. The information providing apparatus according to claim 1, wherein the management unit creates the identity verification information on the passenger based on passenger information and the passage history information related to the passenger.

4. The information providing apparatus according to claim 1, wherein the management unit creates identity verification information on the passenger corresponding to the passenger information from the passage history information extracted based on the passenger information related to the passenger.

5. The information providing apparatus according to claim 1, wherein the management unit creates the identity verification information based on a date of entry to a country or a period of stay of the passenger.

6. The information providing apparatus according to claim 1, wherein the management unit creates the identity verification information on the passenger based on the latest passage history information related to the passenger.

7. The information providing apparatus according to claim 1, wherein the management unit deletes the identity verification information related to the passenger after the passenger departs from a country or after a period of stay expires.

8. The information providing apparatus according to claim 1, wherein the management unit creates the identity verification information for the passenger who permitted a use of the passage history information intended for identity verification.

9. The information providing apparatus according to claim 1, wherein the management unit transmits the identity verification information including the biometric information that matches the biometric information on the target person to a terminal that transmitted permission information indicating permission of a use of the passage history information intended for identity verification.

10. A terminal configured to communicate with an information providing apparatus, wherein the information providing apparatus includes
a management unit that creates identity verification information on a passenger based on passage history information including biometric information on the passenger, and
a transmission unit that, in response to receiving biometric information on a target person and a request for the identity verification information, transmits the identity verification information including the biometric information that matches the biometric information on the target person,
the terminal comprising:
a transmission unit that transmits the biometric information on the target person and the request for the identity verification information to the information providing apparatus; and
a receiving unit that receives a response to the request from the information providing apparatus.

11. The terminal according to claim 10 further comprising a report unit that externally transmits position information that specifies a position of the target person when the identity verification information is not included in the response.

12. The terminal according to claim 10, wherein the terminal is a terminal installed in a facility in which identity verification of the target person is performed or a terminal possessed or carried by the target person.

13. An identity verification system comprising: an information providing apparatus; and a terminal configured to communicate with the information providing apparatus,
wherein the information providing apparatus includes
a management unit that creates identity verification information on a passenger based on passage history information including biometric information on the passenger, and
a transmission unit that, in response to receiving biometric information on a target person and a request for the identity verification information, transmits the identity verification information including the biometric information that matches the biometric information on the target person, and
wherein the terminal includes
a transmission unit that transmits the biometric information on the target person and the request for the identity verification information to the information providing apparatus, and
a receiving unit that receives a response to the request from the information providing apparatus.

14. An information providing method comprising:
creating identity verification information on a passenger based on passage history information including biometric information on the passenger; and
in response to receiving biometric information on a target person and a request for the identity verification information, transmitting the identity verification information including the biometric information that matches the biometric information on the target person.

15. A non-transitory storage medium storing a program that causes a computer to perform:
creating identity verification information on a passenger based on passage history information including biometric information on the passenger; and
in response to receiving biometric information on a target person and a request for the identity verification information, transmitting the identity verification information including the biometric information that matches the biometric information on the target person.
